(19) United States
(12) Patent Application Publication
(10) Pub. No.: US 2010/0123067 A1
(43) Pub. Date: May 20, 2010

(54) Bow caddy

(76) Inventor: John Cardenas, Vernon, CA (US)

Correspondence Address: Harrington & Harrington;Curtis L. Harrington, 6300 State University Drive, Suite 250, Long Beach, CA, 90815, US

(21) Appl. No.: 12/313,189

(22) Filed: Nov. 17, 2008

(51) Int. Cl. F16M 13/00

(52) U.S. Cl. 248/530

(57) ABSTRACT

A deployable and stowable bow caddy has an upper support section with a pair of horizontal members for supporting a bow without damage to any delicate components extending from the bow. The upper support is supported by a lower section which may be sub-divided into further smaller sections for more convenient storage and carriage. The support components may preferably be hollow tubular construction for strength and light weight. The handle sections will preferably be coated with a protective elastomeric coating which will not only prevent any damage to the bow, but will prevent the bow from sliding while the bow is being supported.

### FIELD OF THE INVENTION

The present invention relates to a safe, convenient, stowable and readily deployable structure for gently and stably holding a bow in a horizontal position such that it can be easily retrieved and replaced onto the stand without damaging many small delicate components on a bow which can become unwieldy and in danger of damage if placed on a table, the ground or other flat surface. Also disclosed are an optionally utilizable and optionally configurable support which can be used for supporting arrows in a ready position or for supporting other structures.

### BACKGROUND OF THE INVENTION

Bows used in archery have come a long way from simple bendable structures with ends joined with strings. Modern bows include cammed wheel inset within the ends of the bow, with a multi-path string extending through the bow, and cams. Balancing structures can extend at angles from the bow, including downward and outward to help stabilize the bow while shooting. Complex and protruding aiming sight structures can extend from the center of the bow in all directions, although typically more to one side than the other to accommodate left and right handed shooters. Aiming structures may be adjustable to optimally serve each shooter.

A modern bow which is simply laid, even carefully, on a flat surface will likely damage, even as little as temporarily, the structures extending from it. Further, generally it is understood that bows are expensive, complex instruments which would not be laid on the ground or in any location where dirt, debris, moisture and the like could ruin it.

Permanent structures which would support bows in a well equipped archery range are still not widely available. Further, most archery shooting and practice does not occur within a dedicated range, not only because the cost is prohibitive, but because the best practice occurs under actual conditions. Many archery enthusiasts are bow hunters and prefer to practice in the areas in which they hunt. Others prefer to practice in an open field so that they can readily see and retrieve arrows, particularly those arrows which have gone astray. Archery practice may also involve longer training sessions, differing locations depending upon the weather and time of day sessions, and for changing daylight. The ability to quickly move and set-up in a different location is advantageous.

What is needed is a bow support system which is lighter, can be stowed and deployed in minutes and can shift location depending upon changing shade and weather conditions. The bow support system should have the capability for support of additional items, both to keep them off the ground as well as to put them in a convenient position for users.

### SUMMARY OF THE INVENTION

A deployable and stowable bow caddy has an upper section which has been said to resemble a bicycle handle bar, and which is supported by a lower section which may be sub-divided into further smaller sections for storage and carriage. The support for the upper section inserts into the ground and uses a triangular shaped symmetrical piece of sheet metal with curved upper portions to assist the user's use of foot pressure 35. The upper section is detachably removable from and attachable to the lower section and one or more intermediate sections can be used in order to make the complete bow caddy stowable within a smaller volume. The support components may preferably be hollow tubular construction. The lowest of a support section may preferably have a pinched tip for strengthened resistance to any deformation upon being inserted into the soil. A triangular shaped symmetrical piece of sheet metal is attached to the lower section which includes upper angled portions for providing a step assist upon insertion into the soil. The triangular shaped symmetrical piece of sheet metal provides additional resistance to tipping and enables the user to generally avoiding the necessity to apply a striking force to the structure.

Insertable into the lower section is middle section riser tube having a pair of spring urged locking buttons which are manually depressable to enable riser tube entry and which snap into complementary apertures in other tubular structures to which they are attached. Attachable over the middle section is a support section with a short vertical section attached to a central horizontal support. A pair of handle shaped portions extend from the horizontal support generally parallel to each other with slightly upturned ends to prevent a bow from sliding off or being pushed off by wind. Further, the handle sections will preferably be coated with a protective elastomeric coating which will not only prevent any damage to the bow, but will prevent the bow from sliding while the bow is being supported.

An optional structure can be easily supported from the central horizontal support and one such support is illustrated which hooks over the center of the central horizontal support. The illustrated structure has two pairs of horizontal rings with each set of two horizontal rings having an underlying tab extension. This optional structure can be used to hold anything, including arrows, cold drinks and more.

Cleaning the bow caddy is a simple task. All a user would need do is brush off or tap the lower section to remove any soil present. All of the supporting components are preferably smooth finished and can be cleaned of debris with a damp cloth. A stowage and carriage support structure such as a bag or box can be used to carry and store the bow caddy when not in use.

### BRIEF DESCRIPTION OF THE DRAWINGS

The invention, its configuration, construction, and operation will be best further described in the following detailed description, taken in conjunction with the accompanying drawings in which:

FIG. 1 is a perspective exploded view of the standing bow caddy with optional utility support illustrating the matter of assembly and breakdown;

FIG. 2 is a perspective view of the standing bow caddy as seen in FIG. 1, but in assembled condition;

FIG. 3 is a separate perspective view of the optional utility support configured with a pair of soft holders, one holding a bottle drink and one holding a bottle of water; and

FIG. 4 illustrates a bow being supported by the bow caddy with the upper soft holder removed so that arrows can be supported by the upper and lower pair of horizontal rings with the tips resting in a lower soft holder.

### DETAILED DESCRIPTION OF THE PREFERRED EMBODIMENT

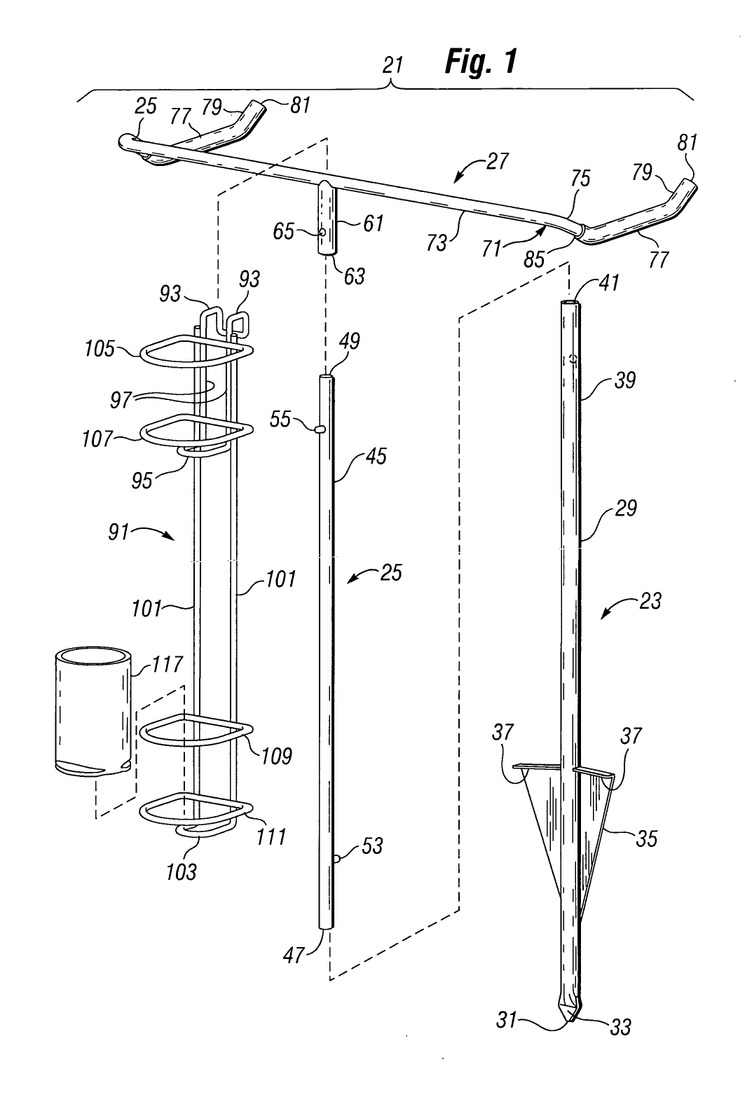

The inventive deployable and stowable bow caddy is best explained with reference to FIG. 1 which illustrates a perspective exploded view of a bow caddy 21 so that the connectivity can be explained. The main structural components of the bow caddy 21 include a lower section 23 for insertion into the ground, a middle riser section 25, and a handle bar shaped upper support section 27. It is understood that the lower section 23 and middle riser section 25 could be combined into one single piece which could not be further broken down for storage. Further, lower section 23 middle riser section 25, and handle bar shaped upper support section 27 could be formed as a single piece, with no break down and smaller dimension stowage whatsoever. However, it is believed that the optimum use, carriage and convenience will be had with a structure which can be broken down and stowed, and even carried, in a small bag or other container.

The main components of the bow caddy 21 can be made of stainless or carbon steel. The bow caddy 21 can also be coated with powder coat, nickel plating, and chrome plating. All of the above make the bow caddy 21 impervious to rust or corrosion.

Bow caddy 21 lower section 23 which includes a tube 29 which is preferably a hollow metal tube having a lower tip 31. Just above lower tip 31 is a flattened area 33 for hardening and reducing the cross section area and for transitioning to a circular or oval tubular cross section which exists just above the flattened area 33. A triangular shaped symmetrical piece of sheet metal 35 is attached to the tube 29. The triangular shaped symmetrical piece of sheet metal 35 has a centerline which is generally parallel to a centerline of the lower tube 25 and tapers in the direction of tip 31. The upper edges of the a triangular shaped symmetrical piece of sheet metal 35 on either side of the lower tube 25 have top angled portions 37 which provide slightly more width than the thickness of the a triangular shaped symmetrical piece of sheet metal 35 to enable a user to more easily use foot pressure to help push the tip 31 further into the ground. An aperture 39 is used to make a secure connection with the middle riser section 25. An upper tubular end 41 is sized to accept connection with the middle riser section 25.

The middle riser section 25 includes a tube 45 having a first end 47 and a second end 49. The first end 47 of tube 45 is shown as fittable into the upper tubular end 41 of lower section 23, although other relative sizes and interconnectivity is possible. A first spring urged locking button 53 is adjacent first end 47 of the middle riser section 25, and a second spring urged locking button 55 is adjacent second end 49 of the middle riser section 25. The tube 45 can be of any length. The lengths chosen for the lower section 23 and middle riser section 25, as well as the width of the upper support section 27 will depend upon the extent to which compact stowability is desired.

The upper support section 27 includes a vertical connection tube 61 having a lower opening 63 for accepting entry of the second end 49 of the middle riser section 25. Vertical connection tube 61 includes an aperture 65 for engaging the second spring urged locking button 55 adjacent second end 49 of the middle riser section 25. The top of the vertical connection tube is affixed to a curving horizontal tube section 71 which includes a generally linear horizontal middle portion 73. From the middle portion 73, and in each direction, the tube section 71 at both ends turns laterally with respect to the middle portion 73 and downwardly through a downward sloping section 75 and then each to a generally horizontal support portion 77 generally extending away from the middle portion 73 and orthogonal to the vertical connection tube 61. Each of the horizontal portions 77 turn upward into an upwardly slanted portion 79 and each terminates at an end 81.

A portion of the downward sloping section 75 and all of the generally horizontal support portion 77 and upwardly slanted portion 79 may preferably be covered with a soft polymeric material 85, such as a foam rubber or flexible plastic. The soft polymeric material 85 may or may not extend over the ends 81. The portions 77, 79 and 81 may be covered with a slipped on polymeric material 85, or these structures may be dipped. The main idea is that some non-scratch, non-marring structure is provided to avoid damage to a bow (not yet shown).

To the left side of FIG. 1, an optional utilizable and optionally configurable support 91 is shown which may be made out of steel wire, and which will hang at the middle of the generally horizontal support portion 77. The preferable diameter for this steel wire may be about one eighth of an inch. The components of the support 91 can be cut, bent and welded in a number of ways. Briefly, one portion of the upper end of the support 91 includes an loop which includes a pair of upper “U” shaped members 93 which can fit over the generally linear horizontal middle portion 73 of the bow caddy 21 such that the support 91 can be stably supported by the bow caddy 21. The loop has a lower end at a first horizontal support lip 95 at the bottom of a pair of vertical lengths 97. Welded along the pair of vertical lengths 97 of the loop is a pair of main extended vertical supports 101 which terminate at a lower end with a second horizontal support lip 103.

A series of four horizontally extending loops 105, 107, 109 and 111 extend from the pair of main extended vertical supports 101. Loops 105 and 107 may also be attached to the pair of vertical lengths 97. As can be seen loops 105 and 107 are relatively close to each other and overlie a structure extending underneath the loop 107 seen as lip 95, while loops 109 and 111 are relatively close to each other, and overlie a structure extending underneath the loop 111 seen as lip 103. The lips 95 and 103 need not be in the form of a curved loop but may be a single projection terminating at an end simply to form a stable cradle for a cylindrical object. A cylindrically shaped container 117 having an upper open end may be placed within the loops 105, 107, 109 and 111 to form containment for loose objects or for bottles or other containers. Container 117 may be a soft, lightweight structure such as a drink insulator or the like. Two such containers 117 can be used in the support 91 shown. Another advantage in the use of containers 117 is that a lightweight surface on which to write instructions, logos and other writing will be provided on the bow caddy 21 structure which otherwise has a thin dimensional profile. Where bow caddy 21 is used multiply within an common institution, the use of a replaceable container 117 enables a look of uniformity.

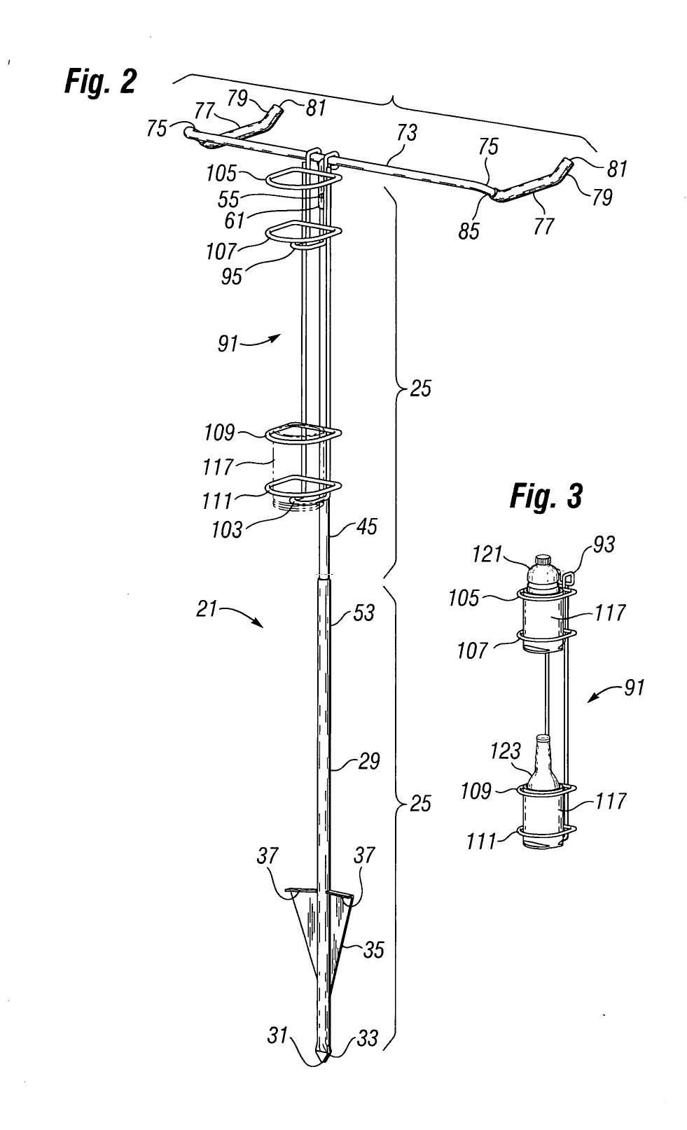

Referring to FIG. 2, a perspective view illustrating the bow caddy 21 in assembled form with support 91 attached, is shown. Only one cylindrically shaped container 117 is illustrated and it is shown in phantom, so that the other components of the bow caddy 21 can be more readily seen in assembled form. Once the tube 45 of the middle riser section 25 is attached to the lower section 23 and once upper support section 27 is attached to the middle riser section 25, a stable bow caddy 21 support will be formed. Support 91 can then be attached to upper support section 27 and it will be stably supported.

Referring to FIG. 3, a separate perspective view of the optional support 91 is shown supporting additional containers 117. An upper container 117 supports a water bottle 121, for example, and a lower container 117 supports a soft drink bottle 123. In the alternative, the containers 117 can be eliminated with the water bottle 121 and soft drink bottle 123 supported by the horizontally extending loops 105, 107, 109 and 111, directly. The containers 117 shown are supported by the first and second horizontal support lips 95 and 103 which are obscured from view by the structures they support in FIG. 3.

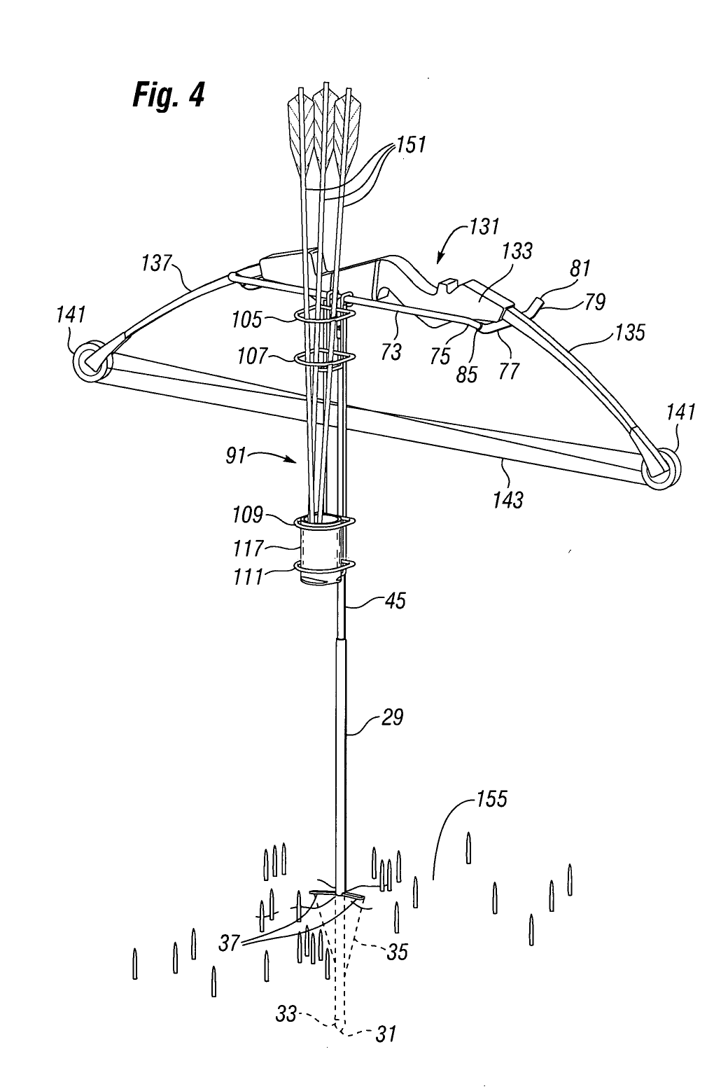

Referring to FIG. 4, a bow 131 is shown as being supported by the bow caddy 21. Bow 131 has a central section 133 and a pair of extending members 135 and 137 extending from either side of the central section 133. The bow 131 is a compound bow having cam wheels 141 and connecting bow string 143. In the position shown, the cam wheels 141 and bow string 143 are supported and free from any interference from the other parts of the bow caddy 21. The manner in which the handle bar shaped upper support section 27 and in particular the generally horizontal support portion 77 allows a user to grasp the bow 131 with the hand to be used to grasp and hold the middle section 133 and lift it gently from the generally horizontal support portion 77 and bring the bow 131 into firing position with less effort than as if it were lifted from a flat surface, or as if it had to be grasped from an angle which would cause the hand to interfere with either the bow string 143 or other structures extending from the bow 131. The bow 131 can be easily placed back onto the bow caddy 21 with minimum effort and the knowledge that none of the components and accessories extending from the bow (not shown, as they may be many and varied) will be damaged or have any interference.

A series of arrows 151 are shown laterally supported through the horizontally extending loops 105 and 107 with the horizontally extending loops 109 and 111 shown supporting container 117 which is used to vertically support and horizontally stabilize the bottom of the arrows 151. Many other supports can be attached to the bow caddy 131 and the optional support 91 can be reconfigured for other uses.

At the bottom of FIG. 4, a lower portion of the lower section 23 is shown as being underground, below a ground level 155. The angled portions 37 are shown slightly above the level of the ground 155 and therefore shown in dash line format.

In general, the bow caddy 21 can be dis-assembled and stored in a bag or other structure and can be easily carried from or to the bow practice field. Setup requires two tubular attachments and ground 155 implantation of the lower section 23. Bow caddy 21 is of simple construction, is user-friendly, and can support many other structures for the help and convenience of the bow shooter. The placement of the triangular shaped symmetrical piece of sheet metal 35 makes it convenient for a user because a user would only have to use one foot on the sheet metal piece to secure the bow caddy firmly into the ground. The lower tip 31 and flattened area 33 provide a strong, sturdy insertion structure for insertion into many different types of ground, such as, muddy, dry, hard, or even sandy. The placement of the triangular shaped symmetrical piece of sheet metal 35 sheet metal is also a good selective stabilization structure for the bow caddy 21. Because the triangular shaped symmetrical piece of sheet metal 35 extends normal to the direction of the tube 29, weight support force resistance along the direction of the tube 29 to the side of the bow caddy 21 supporting the bow 131 is enhanced. When being extracted from the ground, a side to side rocking motion can facilitate the removal of the bow caddy 21.

As can be seen from the configuration of FIG. 4, a shooter can stand behind bow caddy 21, and easily retrieve the bow 131 to shoot and easily replace it on the bow caddy 21 when not firing. The bow caddy 21 during firing becomes an arrow 151 supply stand to give the shooter easy access to arrows for firing at a target. When the arrows 151 are to be retrieved, the bow caddy 21 can hold the bow 131, to free the shooter to retrieve arrows 151 and replace them in the support 91 ready for another round of firing, all without having to either carry the bow 131 or place it on the ground 155.

While the present system has been described in terms of bow support structure which be easily dis-assembled for storage or carriage, and which can support attachment of other utility structures, one skilled in the art will realize that the structure and techniques of the present system can be applied to many structures which utilize the several aspects of the embodiment and optional supports and containers, including those not shown.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A bow caddy comprising:
a lower section tube having a first end having a closed tip end for insertion into the ground and a second tubular end;
a triangular shaped sheet metal member attached to the lower tube section and tapering toward the tip end for providing enhanced stabilization of the lower section tube in at least one direction;
an upper support section attachably supported by the lower section tube and detachably removal from the lower section tube, the upper support section including a middle portion supporting pair of spaced apart generally parallel support portions extending symmetrically away from a center of the middle portion, for supporting a bow.

2. The bow caddy as recited in claim 1 and further comprising a middle riser section tube having a first end removably attached to the lower section tube and a second end removably attached to the upper support section so that the bow caddy can be dis-assembled into a more compact space.

3. The bow caddy as recited in claim 2 wherein the triangular shaped sheet metal member first upper angled portion and a second upper angled portion for facilitating foot pressure on the triangular shaped sheet metal member to assist a user in inserting the attached lower section tube into the ground.

4. The bow caddy as recited in claim 1 and further comprising a support having at least one member extending over the upper support section and supported by the upper support section, the support having at least one main extended member supporting at least one horizontally extending loop and having at least one lip structure extending underneath the at least one horizontally extending loop.

5. The bow caddy as recited in claim 4 and further comprising a cylindrical container having an upper open end supported within the at least one horizontally extending loop.
